(19) United States
(12) Patent Application Publication
(10) Pub. No.: US 2024/0404735 A1
(43) Pub. Date: Dec. 5, 2024

(54) ELECTRICAL FEEDTHROUGH AND METHOD FOR THE PRODUCTION THEREOF

(71) Applicant: Vitesco Technologies GmbH, Regensburg (DE)

(72) Inventors: Jan HODGSON, Troisdorf (DE); Rolf BRÜCK, Bergisch Gladbach (DE); Peter HIRTH, Rösrath (DE)

(21) Appl. No.: 18/698,103

(22) PCT Filed: Sep. 22, 2022
(86) PCT No.: PCT/EP2022/076438

§ 371 Date: Apr. 3, 2024

(30) Foreign Application Priority Data
Oct. 5, 2021 (DE) 10 2021 211 205.6

(51) Int. Cl. H01B 17/26; F01N 3/20; H01B 19/00; H05B 3/10

(52) U.S. Cl. CPC H01B 17/26; H01B 19/00; H05B 3/10; F01N 3/2026; H05B 2203/016; H05B 2203/024

(57) ABSTRACT

An electrical feedthrough and a method for producing an electrical feedthrough for contacting a heating conductor of an electrically heatable honeycomb body, comprising an electrically conductive pin, an electrically insulating insulation layer and a bushing in which the insulation layer and the pin are at least partially accommodated. The pin is arranged centrally and at least some portions of it are completely surrounded in the circumferential direction by the insulation layer. The three elements are connected to one another by a form fit and/or a force fit such that they cannot be separated non-destructively.

### CROSS REFERENCE TO RELATED APPLICATIONS

This is a U.S. national stage of Application No. PCT/EP2022/076438 filed Sep. 22, 2022. Priority is claimed on German Application No. DE 10 2021 211 205.6 filed Oct. 5, 2021, the content of which is incorporated herein by reference.

### BACKGROUND OF THE INVENTION

### 1. Field of the Invention

The disclosure relates to an electrical feedthrough for contacting a heat conductor of an electrically heatable honeycomb body, comprising an electrically conductive pin, an electrically insulating insulation layer, and a bushing in which the insulation layer and the pin are at least partially accommodated, wherein the pin is arranged centrally and at least some portions of it are completely surrounded in the circumferential direction by the insulation layer. The invention also relates to a method for producing an electrical feedthrough.

### 2. Description of the Related Art

Heating of exhaust gases in an exhaust gas tract downstream of an internal combustion engine or of the exhaust gas flowing in an exhaust gas tract is nowadays regularly accomplished using electrical heating elements. The aim is to more quickly attain a temperature threshold from which effective transformation of the pollutants entrained in the exhaust gas is possible. This is necessary since the catalytically active surfaces of the catalysts installed in the exhaust gas tract that are used for exhaust gas aftertreatment only enables sufficient conversion of the respective pollutants from a minimum temperature, called the lightoff temperature.

The known solutions in the prior art include what are called heated catalytic converters having a metallic structure connected to a voltage source or a metal-coated ceramic structure, which can be heated up by exploitation of ohmic resistance.

For the purpose of electrical contact connection of the heatable structure, it is necessary to insert an electrical conductor through the housing of the exhaust gas tract or of a catalytic converter arranged in the exhaust gas tract at at least one point. It is necessary here to ensure that the feedthrough is gas-tight, and also that there is electrical insulation between the housing and the electrical conductor, and that sufficient long-term durability is assured. The electrical conductor is routinely formed from a solid material, such as a metal pin.

DE 10 2012 110 098 B4 discloses a method for producing an electrical feedthrough for the power supply of an electrical exhaust gas heating system in a motor vehicle. The feedthrough has an outer tube, with an electrical conductor passing through its interior. The electrical conductor protrudes beyond the outer tube at at least one end face of the outer tube. The electrical conductor is surrounded in the interior of the outer tube by an insulating material. The feedthrough is generated by trimming a compacted rod material, wherein regions of the portion functioning as outer tube and of the portion functioning as insulating material by machining methods in order to thus generate an electrical feedthrough of the desired length with a desired projection of the electrical conductor beyond the outer tube.

A disadvantage of the methods known in the prior art for producing an electrical feedthrough is that the compacted bar material used is very costly, as it has a multi-layer structure. In addition, a significant proportion of approximately two thirds of the bar material is destroyed unused by machining to cut the electrical conductor and to trim the electrical feedthrough to length and is therefore wasted. The production process is therefore particularly complex and cost-intensive.

### SUMMARY OF THE INVENTION

It is therefore the object of one aspect of the present invention to create an electrical feedthrough for contacting an electrically heatable honeycomb body, which is simpler and less expensive to produce than the solutions known in the prior art. The object of the invention is also to provide a method for producing an electrical feedthrough.

One exemplary aspect of the invention relates to an electrical feedthrough for contacting a heating conductor of an electrically heatable honeycomb body, comprising an electrically conductive pin, an electrically insulating insulation layer and a bushing in which the insulation layer and the pin are at least partially accommodated, wherein the pin is arranged centrally and at least some portions of it are completely surrounded in the circumferential direction by the insulation layer, wherein the three elements are connected to one another by a form fit and/or a force fit such that they cannot be separated non-destructively.

The electrical feedthrough is constructed from the three individual elements of the pin, insulation layer, and bushing. The components are arranged as follows in accordance with one aspect of the invention. The pin, which represents the current-conducting element, is arranged centrally. The insulation layer completely surrounds the pin in the circumferential direction and extends in the axial direction at least along a portion of the pin. The insulating layer is followed radially on the outside by the bushing, which serves as a fastening element for the entire electrical feedthrough on a housing or a casing tube of a catalytic converter.

The bushing is completely electrically insulated from the pin by the insulation layer, so that an electrical short circuit between the pin and the bushing or the housing connected to the bushing is prevented.

According to one aspect of the invention, the three components described above are connected to one another by means of a form fit and/or a force fit. Basically, this means that a force is exerted on individual or several components after assembly, which leads to at least partial plastic deformation, resulting in a force fit between the components. Depending on the design of the components, this can also create a form fit.

This is particularly advantageous as all three components can be produced independently of each other and are therefore particularly cost-effective to produce. For example, the pin can simply be sawn from a solid material. The bushing can also be sawn from a hollow-cylindrical material, such as a tube. The insulation layer, which is preferably formed from an oxide ceramic, can be easily produced using a suitable method, such as sintering.

It is particularly advantageous if a radial and/or axial force on the outer surface of the bushing creates a form fit and/or force fit between the bushing, the insulation layer and the pin.

The application of a force component, for example a radially inwardly directed compressive force on the radial outer surface, leads to compression of the bushing in the radial direction. If the deformation exceeds the elastic component and at least partial plastic deformation is achieved, this creates a preload between the bushing and the insulation layer, which leads to a permanent force fit between the bushing and the insulation layer.

If the force directed radially inwards is large enough, this can also generate a preload between the insulation layer and the pin. The force component can be applied using a pressing tool, for example, by radially and/or axially compression of the bushing.

It is also advantageous if an axial and/or radial force on the insulation layer creates a form fit and/or force fit between the insulation layer and the bushing and/or between the insulation layer and the pin.

An axial force component can preferably be applied to the insulation layer. This causes the insulation layer to undergo axial compression, which also leads to a widening in the radial direction, which ultimately creates a preload between the insulation layer and the pin or bushing.

If the insulation layer protrudes beyond the bushing in the axial direction, a radial force can also be exerted on the insulation layer in a simple manner, for example to generate a preload towards the pin.

A preferred exemplary aspect is characterized in that an axial and/or radial force acting on the pin from the inside creates a form fit and/or force fit between the pin and the insulation layer and/or the insulation layer and the bushing.

Axial or radial forces on the bushing and/or the insulation layer can substantially create compression, which can generate a preload directed inwards towards the center of the electrical feedthrough.

The pin arranged in the center can preferably be expanded by a radially outwardly directed force component, whereby a radially outwardly directed preload is generated. The pin can preferably have an opening for this purpose, such as an axial bore, into which an expansion tool can be inserted in order to expand the pin by applying force. Alternatively, the pin could be subjected to high internal pressure, for example pneumatic or hydraulic pressure.

It is essential that the pin undergoes permanent, i.e., plastic, deformation as a result of the acting force component, said deformation being sufficiently large to ensure that the resulting preload on the insulation layer and the bushing is sufficient to make the electrical feedthrough durable.

It is also preferable if the pin has an axial cutout to accommodate a shaped piece.

A suitable shaped part can be inserted or pressed into a cutout, for example a conically tapered bore, which can also generate a radially outwardly directed force component on the pin and, if necessary, on the insulation layer and the bushing.

The shaped part is preferably designed in such a way that it has a certain oversize compared to the cutout and thus an expansion of the pin is achieved by pressing in the shaped part, whereby a preload on the insulation layer and the bushing is achieved.

In addition, it is advantageous if the insulation layer and/or the bushing and/or the pin have alternating concave or convex contact surfaces via which they are in contact with each other.

This is advantageous in order to create a form fit in addition to the force fit, which is achieved by expanding or compressing individual components. This can make the connection between the components more durable and can support the force fit. The pin can, for example, have a wedge-shaped groove running in the circumferential direction on its contact surface facing the insulation layer. The insulation layer can have a wedge-shaped, roof-like contact surface, which causes the insulation layer to lock into the pin. Such a form fit can also be formed between the insulation layer and the bushing.

Alternatively, the contact surfaces between the components can have grooves or ridges or otherwise corresponding recesses and projections. Preferably, there is a certain oversize in each case, so that a preload occurs between the components in the assembled state.

It is also advantageous if the contact surfaces between the pin and the insulation layer and/or between the insulation layer and the bushing have surface-enlarging elements. Surface-enlarging elements are in particular dimples, furrows, grooves, beads, but also specifically introduced roughnesses.

One aspect of the invention relates to a method for producing an electrical feedthrough, wherein a force component is applied to at least one of the components from the series of bushings, pins or insulation layer after assembly and produces a permanent plastic deformation of at least that component to which the force component has been applied.

Applying the force components after assembly ensures that the individual components are generally easy to assemble, as the fits created between the components can be sufficiently dimensioned, as the hold between the components is not necessarily created via these. Only by applying the force component is a permanent plastic deformation of individual or all components finally produced, which creates a permanently durable connection between the components.

It is also useful if an internal pressure is generated in a cutout in the pin, which causes the pin to expand in a radial direction and permanently increases the outer diameter even after the excess pressure has been released.

By generating an internal pressure in a cutout in the pin, the pin can be expanded, resulting in the formation of a preload on the insulation layer and/or the bushing. Preferably, the internal pressure is generated hydraulically or pneumatically.

Alternatively, a shaped piece that does not remain in the cutout can be pressed into the recess, which expands the pin and creates the necessary preload for the insulation layer. Once the pin has been plastically deformed, the corresponding shaped piece, for example a punch from a press, can be removed again.

In addition, it is advantageous if a shaped part is pressed into a cutout in the pin, wherein the pin is expanded in a radial direction and a preload is generated on the insulation layer and/or the bushing.

In an alternative aspect of the method, the shaped part can also remain in the pin and thus increase the stability of the pin and ensure that the generated preload is maintained.

Furthermore, it is expedient if the bushing and/or the pin and/or the insulation layer are thermally pretreated in order to produce a temporary enlargement or reduction in the diameter of the respective component, wherein the components are joined together after the temporary enlargement or reduction has been produced and the joined components are then heated or cooled in order to produce a compression between the bushing, the insulation layer and the pin.

A shrinkage or expansion of individual components can be achieved by thermal pre-treatment, for example by strong cooling or strong heating. Subsequent cooling in the case of a heated component results in shrinkage, which can lead to the creation of a preload in relation to an inserted component. Conversely, the cooling process will cause shrinkage and the subsequent heating process will cause expansion, which can also result in a preload in relation to another component.

Components that are inserted into something, for example the pin in the insulation layer, are preferably shrunk by cooling. Components into which something is inserted, for example the insulation layer in the feedthrough, are heated and thus expanded. A combination of both methods for the different components of the electrical feedthrough is also possible.

Advantageous developments of the present invention are described in the dependent claims and in the following description of the figures.

### BRIEF DESCRIPTION OF THE DRAWINGS

The invention will be explained in more detail hereunder by means of exemplary embodiments with reference to the drawings, in which:

FIG. 1 is a sectional view through a pin, an insulation layer and a bushing, wherein the individual components are shown in a non-assembled state;

FIG. 2 are two sectional views through one electrical feedthrough each, wherein the contact surfaces of the individual components are designed differently to one another;

FIG. 3 is a sectional view through an electrical feedthrough, wherein an internal pressure is generated in a cavity in the pin; and

FIG. 4 is a sectional view through an electrical feedthrough, wherein a shaped part is pressed into a cutout in the pin.

### DETAILED DESCRIPTION OF THE PRESENTLY PREFERRED EMBODIMENTS

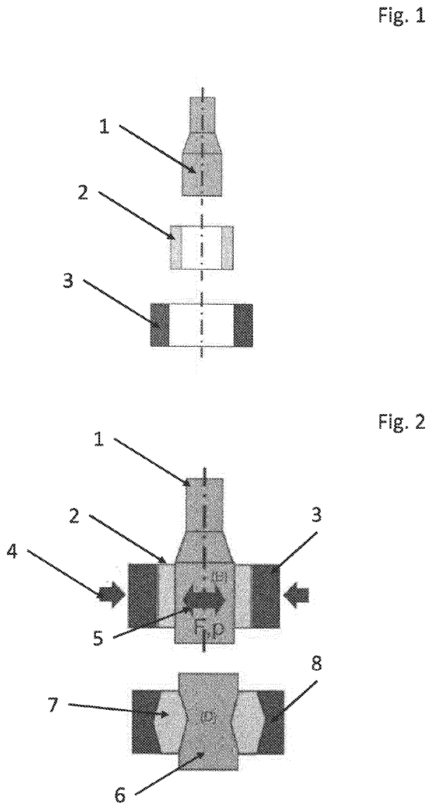

FIG. 1 shows the individual components of the electrical feedthrough. The pin 1, which forms the current conductor and is preferably made from a solid material, is located centrally. The pin 1 can be adapted to the geometric requirements by means of suitable post-processing. All conventional machining methods can be used for this purpose.

The insulation layer 2 is shown as an annular sleeve. The insulation layer is preferably made from a pressed oxide ceramic. The inner cross-section of the ring-like insulation layer 2 is preferably designed in such a way that the pin 1 can be accommodated.

Reference sign 3 shows the bushing, which is also ring-like in the example shown in FIG. 1. The inner diameter of the bushing 3 is selected so that the insulation layer 2 can be inserted into the bushing 3.

The components are shown exploded in FIG. 1 in the unassembled state.

The upper part of FIG. 2 shows an assembly of the components shown in FIG. 1. The pin 1 is arranged centrally, the insulation layer 2 surrounds the pin 1, and the bushing 3 accommodates the insulation layer 2 with the pin 1.

FIG. 2 is an example of an electrical feedthrough and does not exclude other geometric configurations in particular. Properties such as the length of the individual components, projections of the components relative to one another, material thicknesses and materials in general are not restricted by FIG. 2.

The arrow 4 indicates the direction of action of a force component acting in the radial direction, which can be applied to the outside of the bushing 3, causing compression of the bushing 3 and, as a result, a preload between the components.

The reference sign 5 indicates the direction of action of a force component that can act radially outwards from the inside. This could, for example, act from the inside on the insulation layer 2 or, if the pin 1 has a cutout suitable for this, from the inside on the pin 1.

The lower part of FIG. 2 shows alternative designs for the pin 6, the insulation layer 7 and the bushing 8. The insulation layer 7 has roof-like contact surfaces that protrude in a radial direction. The bushing 8 and the pin 6 each have contact surfaces that correspond to the shape of the insulation layer 7. The design of the contact surfaces between the components enables a form fit to be achieved in addition to the force fit.

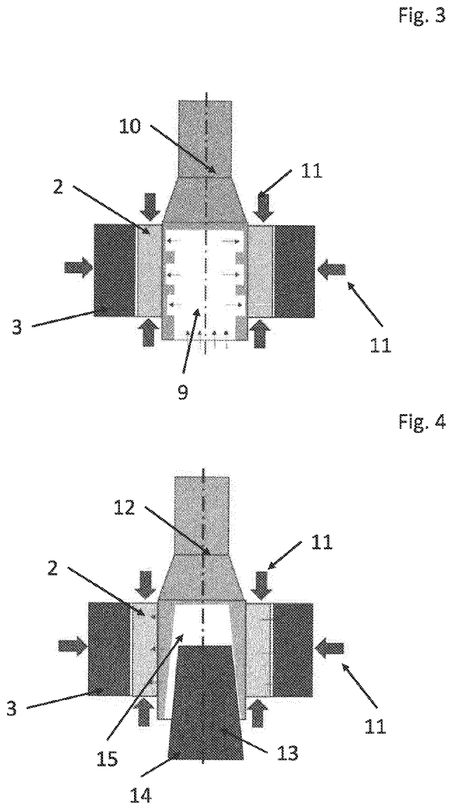

FIG. 3 shows an assembled electrical feedthrough as already shown in the upper part of FIG. 2. In contrast to FIG. 2, the pin 10 here has a cutout 9, which has been made in the axial direction from below in the pin 10. Suitable means can be used to generate an overpressure in the cutout 9, which is shown by the arrows indicated inside the cutout. This generated internal pressure can achieve radial and axial expansion of the pin 10.

Furthermore, arrows are shown in FIG. 3 with the reference sign 11, which indicate the application of an axial and/or radial force component from the outside to the bushing 3 or the insulation layer 2.

FIG. 4 shows an alternative configuration of the pin 12. In contrast to FIG. 3, it has a conically tapering cutout 15, into which a shaped body 14 is pressed by means of a force acting along the direction 13, whereby the pin 12 is expanded in the radial and axial direction and a preload is generated towards the insulation layer 2 and towards the bushing 3.

The different features of the individual exemplary embodiments can also be combined with one another. In particular, the application of a force from the outside and the generation of internal pressure in the pin can be combined. The application of a force and a special design of the contact surfaces can also be combined in one exemplary embodiment.

The exemplary embodiments of FIGS. 1 to 4 in particular have no restrictive character and serve to clarify the inventive concept.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-11. (canceled)

12. An electrical feedthrough configured to contact a heating conductor of an electrically heatable honeycomb body, comprising:
a pin that is electrically conductive;
an insulation layer that is electrically insulating; and
a bushing in which the insulation layer and the pin are at least partially accommodated,
wherein the pin is arranged centrally and at least some portions of the pin are completely surrounded in a circumferential direction by the insulation layer,
wherein the pin, the insulation layer, and the bushing are connected to one another by a form fit and/or a force fit such that they cannot be separated non-destructively.

13. The electrical feedthrough as claimed in claim 12, wherein a radial and/or axial force on an outer surface of the bushing creates the form fit and/or force fit between the bushing, the insulation layer, and the pin.

14. The electrical feedthrough as claimed in claim 12, wherein an axial and/or radial force on the insulation layer creates the form fit and/or force fit between the insulation layer and the bushing and/or between the insulation layer and the pin.

15. The electrical feedthrough as claimed in claim 12, wherein an axial and/or radial force acting on the pin from the inside creates the form fit and/or force fit between the pin and the insulation layer and/or the insulation layer and the bushing.

16. The electrical feedthrough as claimed in claim 12, wherein the pin has an axial cutout for receiving a shaped piece.

17. The electrical feedthrough as claimed in claim 12, wherein the insulation layer and/or the bushing and/or the pin have alternating concave or convex contact surfaces via which they are in contact with each other.

18. The electrical feedthrough as claimed in claim 12, wherein respective contact surfaces between the pin and the insulation layer and/or between the insulation layer and the bushing have surface-enlarging elements.

19. A method for producing an electrical feedthrough having an electrically conductive pin, an electrically insulating insulation layer; and a bushing in which the insulation layer and the pin are at least partially accommodated, comprising:
arranging the pin centrally and at least some portions of the pin are completely surrounded in a circumferential direction by the insulation layer;
applying a force component to at least one of the components from the bushing, pin or insulation layer after assembly; and
producing a permanent plastic deformation of at least that component to which the force component has been applied.

20. The method for producing an electrical feedthrough as claimed in claim 19, wherein an internal pressure is generated in a cutout in the pin, which causes the pin to expand in a radial direction and permanently increases the outer diameter even after the excess pressure has been released.

21. The method for producing an electrical feedthrough as claimed in claim 19, wherein a shaped part is pressed into a cutout of the pin, wherein the pin experiences a widening in the radial direction and a preload on the insulation layer and the bushing.

22. The method for producing an electrical feedthrough as claimed in claim 19, wherein the bushing and/or the pin and/or the insulation layer are thermally pretreated to produce a temporary enlargement or reduction in a diameter of the respective component,
wherein the components are joined together after the temporary enlargement or reduction has been produced and the joined components are then heated or cooled in order to produce a compression between the bushing, the insulation layer and the pin.
